(19) United States
(12) Patent Application Publication
(10) Pub. No.: US 2018/0038320 A1
(43) Pub. Date: Feb. 8, 2018

(54) MULTI-STAGE CHECK VALVE FOR VAPOR RECIRCULATION LINE OF LIQUID CONTAINMENT SYSTEM

(71) Applicant: GM GLOBAL TECHNOLOGY OPERATIONS LLC, Detroit, MI (US)

(72) Inventors: Jon J. Waples, Detroit, MI (US); Timothy J. Spry, Rochester Hills, MI (US); Marvin H. Miller, Flushing, MI (US); Jason M. Andrzejewski, Washington, MI (US)

(73) Assignee: GM GLOBAL TECHNOLOGY OPERATIONS LLC, Detroit, MI (US)

(21) Appl. No.: 15/229,741

(22) Filed: Aug. 5, 2016

(51) Int. Cl. F02M 25/08; B60K 15/035; F16K 15/02

(52) U.S. Cl. CPC F02M 25/089; F16K 15/026; F02M 25/0854; F02M 25/0872; F02M 25/0836; B60K 15/03504; B60K 15/03519; B60K 2015/03514; B60K 2015/03256

(57) ABSTRACT

Disclosed herein are liquid containment systems, methods for making such systems, and vehicle fuel storage systems having vapor recirculation capabilities. Presented is a liquid containment system for stowing hydrocarbon-based liquids. This system includes a vapor canister coupled to a liquid container to receive hydrocarbon vapor from the container. A fill conduit coupled to the container has an opening for receiving a fill nozzle. A vapor recirculation transmits vapor from the container to the fill conduit. A multi-stage check valve, which is coupled to the container and recirculation conduit, has a housing and a plunger with a bleed hole. The plunger seats against the housing such that vapor passes from the container through the bleed hole to the fill conduit via the recirculation conduit. Responsive to increased in-tank pressure, the plunger unseats from the housing such that vapor passes through the bleed hole and around the plunger to the fill conduit.

### TECHNICAL FIELD

The present disclosure relates generally to liquid containment systems. More specifically, aspects of this disclosure relate to fuel storage systems with vapor recirculation and vapor capture capabilities for motor vehicles.

### BACKGROUND

A wide array of storage tanks, drums and other fluid-tight containers are used for holding and transporting various types of fluids. As an example, most conventional motor vehicles, such as the modern-day automobile, are originally equipped with an onboard fuel tank for safely storing combustible petroleum-based fuels, such as gasoline and diesel fuel, for use by an internal combustion engine (ICE) assembly. Portable fuel containers, more commonly known as “gas cans” or colloquially as “gas caddies” in some countries, are also available for manually transporting smaller quantities of fuel. Liquefied gas tanks, on the other hand, are stationary containers used to store liquefied petroleum gases, such as propane, propylene, butanes, and butylenes, for use in both industrial and residential applications.

Vehicle fuel tanks are traditionally refilled at public gas stations, also known as filling stations, petrol stations, and petrol garages. Most vehicle fuel tank systems have a fill pipe with a fill cup that is designed to receive a fill pump nozzle that replaces the contents of the fuel tank. To reduce spillage during refilling, nearly all fill pump nozzles include a fill-limiting sensor for discontinuing the flow of fuel from the nozzle when the fuel in the tank reaches a predetermined volume. Typically, such fill-limiting sensors are triggered when the fuel tank is full, and fuel begins to “back up” the filler neck to reach or spray the fill-limiting sensor. To reduce hydrocarbon vapor emissions during and after refilling, many fuel tank systems employ an in-line vapor canister for capturing vapor that is emitted from the fuel tank. The captured vapor is stored by the vapor canister for future consumption by the engine as the vehicle is operated.

When the fuel fill cup is exposed for refueling, e.g., after opening a protective fuel door and/or removing a gas cap, and when fuel is flowing from the fill pump nozzle into the fill pipe, a flexible seal is positioned within some prior art fill cups to prevent the escape of hydrocarbon vapor from the tank through the fill cup that would otherwise bypass the vapor canister. In some arrangements, a recirculation line is fluidly connected at one end to an upper wall of the fuel tank and at another end to the fill pipe below the mechanical seal. The recirculation line permits fuel vapor to be recirculated from the tank through the fill pipe and back into the incoming flow of fuel. This reduces air entrainment by displacing outside air with fuel vapor. In so doing, the recirculation line helps to facilitate flow of the liquid fuel into the fuel tank and concomitantly minimize the discharge of fuel vapor out through the fill pipe to the atmosphere.

### SUMMARY

Disclosed herein are liquid containment systems with multi-stage check valves for controlling fluid flow within vapor recirculation lines, methods for making and methods for using such liquid containment systems, and motor vehicles with fuel storage systems employing two-stage check valves for regulating recirculating vapor volume through fuel vapor recirculation lines. By way of non-limiting example, an improved two-stage unidirectional check valve is inserted into a fuel vapor recirculation line, e.g., interposed between the fuel tank and fill cup, or mounted directly to the fuel tank, e.g., interposed between the recirculation line and interior compartment of the fuel tank. At low fill rates, typically flowing at approximately 4 to 5 gallons/minute or less, in-tank pressures are relatively low (e.g., about 0.25 to 1.25 kilopascal (kPa)); the check valve's spring-biased plunger remains seated such that recirculation vapor flow is limited to passing through a central bleed hole in the plunger. Contrastingly, at high fill rates, e.g., ranging from approximately 8 to 10 gallons/minute, the in-tank pressures are sufficiently high (e.g., 1.25 kPa and above) to unseat and displace the valve plunger. By overcoming the spring force and displacing the plunger, additional recirculating vapor is allowed to flow around the plunger in addition to flow through the hole in the plunger. A reduced-diameter flow restrictor can be added to the vapor canister to increase in-tank pressures during refilling.

Attendant benefits for at least some of the disclosed concepts include the ability to dynamically manage fill-pipe recirculation flow volume with a dedicated multi-stage spring-loaded check valve assembly. The check valve assembly helps to minimize hydrocarbon vapor generation in the fuel tank during gas station refueling by recirculating an optimal volume of vapor for each of multiple fill rates. By saturating the incoming fuel with an optimal volume of existing fuel vapor, a reduced amount of outside air can become entrained with the incoming fuel such that a minimized amount of new vapor is generated. Advantageously, at least some of the disclosed systems ensure that the average vapor introduced into the liquid containment tank during refill is reduced to approximately 4.5 g/gal or less. Disclosed configurations can be easily integrated to efficiently and effectively minimize vapor generation even as vapor canister purge capabilities decrease industry-wide with newer and more efficient powertrains. Other attendant benefits can include lower system costs when compared to conventional measures, such as mechanical seals, vent valves, etc., that are used to address hydrocarbon vapor emissions. By simplifying the overall system architecture, the vapor recirculation system is more robust and, thus, less prone to warranty problems, such as failed nozzle tank pressure issues.

Aspects of the present disclosure are directed to liquid containment systems with vapor recirculation and vapor capture capabilities. Disclosed, for example, is a liquid containment system for stowing a hydrocarbon-based liquid discharged from a fill nozzle. This liquid containment system includes a liquid container with a vapor canister fluidly coupled to the liquid container. The vapor canister receives and stores hydrocarbon vapor from hydrocarbon-based liquid stowed in the liquid container. A fill conduit, which is fluidly coupled to the liquid container, has an open end for receiving hydrocarbon-based liquid from the fill nozzle. A vapor recirculation conduit is fluidly coupled to the liquid container and to the fill conduit proximate the open end thereof. The vapor recirculation conduit transmits hydrocarbon vapor from the liquid container to the fill conduit. The liquid containment system also includes a multi-stage check valve assembly that is fluidly coupled to the liquid container and vapor recirculation conduit. The check valve assembly has a housing and a plunger with a bleed hole. The plunger is movable within the housing to transition back-and-forth between a first (seated) position and a second (unseated) position. When in the first position, the plunger seats against the housing such that hydrocarbon vapor passes from the liquid container through only the bleed hole to the fill conduit via the vapor recirculation conduit. Contrastingly, when in the second position, the plunger unseats from the housing such that hydrocarbon vapor passes from the container through the bleed hole and around the plunger to the fill conduit via the recirculation conduit.

Other aspects of the present disclosure are directed to motor vehicles with fuel storage systems having vapor recirculation and vapor capture capabilities. A “motor vehicle,” as used herein, may include any relevant vehicle platform, such as passenger vehicles (internal combustion engine (ICE), hybrid, electric, fuel cell, etc.), commercial vehicles, industrial vehicles, tracked vehicles, all-terrain vehicles (ATV), farm equipment, motorcycles, boats, airplanes, spacecraft, etc. In an example, a motor vehicle is disclosed that includes an engine mounted to a vehicle body, a fuel tank fluidly coupled to the engine, and a vapor line fluidly coupled to the fuel tank. A vapor canister, which is fluidly coupled to the fuel tank via the vapor line, receives hydrocarbon vapor from fuel stowed in the interior space of the fuel tank, stores the vapor, and purges the vapor to the engine. A fill pipe has a first end fluidly coupled to the fuel tank and a second end fluidly coupled to a fill cup. This fill cup is designed to receive a fill pump nozzle.

The motor vehicle also includes a vapor recirculation line with a first end fluidly coupled to the fuel tank, e.g., via the vapor line, and a second end fluidly coupled to the fill cup. The vapor recirculation line transmits hydrocarbon vapor from the fuel tank into the fill pipe via the fill cup. A one-way two-stage check valve assembly is fluidly coupled to the fuel tank and vapor recirculation line. The check valve assembly has an elongated housing, a spring packaged inside the housing, and a plunger with a bleed hole. The plunger slides back-and-forth within the housing between first and second positions. When in-tank vapor pressure is sufficiently low, the spring biases the plunger towards the first position to seat against the housing such that hydrocarbon vapor passes from the fuel tank through only the bleed hole to the fill cup via the vapor recirculation line. When in-tank vapor pressure exceeds the bias force of the spring, the plunger unseats from the housing and moves to the second position such that hydrocarbon vapor passes through the bleed hole and around the plunger to the fill cup.

In yet other aspects of the present disclosure, methods for making and methods for using liquid storage containers are presented. For instance, a method of constructing a liquid containment system for stowing a hydrocarbon-based liquid discharged from a fill nozzle is disclosed. The method includes, in any order and in any combination: fluidly coupling a vapor canister to a liquid container, the vapor canister being configured to receive and store hydrocarbon vapor from the hydrocarbon-based liquid stowed in the liquid container; fluidly coupling a fill conduit to the liquid container, the fill conduit having an open end configured to receive the hydrocarbon-based liquid from the fill nozzle; fluidly coupling a vapor recirculation conduit to the liquid container and to the fill conduit proximate the open end thereof, the vapor recirculation conduit being configured to transmit hydrocarbon vapor from the liquid container to the fill conduit; and fluidly coupling a multi-stage check valve assembly to the liquid container and the vapor recirculation conduit, the check valve assembly having a housing and a plunger with a bleed hole, the plunger being movable within the housing to transition between a first position, whereat the plunger seats against the housing such that hydrocarbon vapor passes from the liquid container through only the bleed hole to the fill conduit via the vapor recirculation conduit, and a second position, whereat the plunger unseats from the housing such that hydrocarbon vapor passes through the bleed hole and around the plunger to the fill conduit. The method may also include fluidly coupling a flow restrictor between the liquid container and the vapor canister. The flow restrictor is designed to increase the internal pressure within the liquid container. The method may also include fluidly coupling a vapor generation reduction device (VGRD) to the fill conduit. The VGRD regulates in-flow fluid speed and turbulence of the hydrocarbon-based liquid discharged from the fill nozzle.

The above summary is not intended to represent every embodiment or every aspect of the present disclosure. Rather, the foregoing summary merely provides an exemplification of some of the novel aspects and features set forth herein. The above features and advantages, and other features and advantages of the present disclosure, will be readily apparent from the following detailed description of representative embodiments and modes for carrying out the present disclosure when taken in connection with the accompanying drawings and the appended claims.

### BRIEF DESCRIPTION OF THE DRAWINGS

FIG. 1 is an elevated perspective-view illustration of a representative liquid containment system having a vapor canister and a vapor recirculation line with a two-stage check valve in accordance with aspects of the present disclosure.

FIG. 2 is a cross-sectional side-view illustration of the representative two-stage check valve of FIG. 1.

FIG. 3 is a perspective-view illustration of the representative fill pipe and vapor recirculation line of FIG. 1 with an inset view showing a vapor generation reduction device (VGRD) disposed between the fill cup and storage tank.

The present disclosure is susceptible to various modifications and alternative forms, and some representative embodiments have been shown by way of example in the drawings and will be described in detail herein. It should be understood, however, that the novel aspects of this disclosure are not limited to the particular forms disclosed in the drawings. Rather, the disclosure is to cover all modifications, equivalents, combinations, subcombinations, and alternatives falling within the spirit and scope of the disclosure as defined by the appended claims.

### DETAILED DESCRIPTION OF THE ILLUSTRATED EMBODIMENTS

This disclosure is susceptible of embodiment in many different forms. There are shown in the drawings and will herein be described in detail representative embodiments of the disclosure with the understanding that the present disclosure is to be considered as an exemplification of the principles of the disclosure and is not intended to limit the broad aspects of the disclosure to the embodiments illustrated. To that extent, elements and limitations that are disclosed, for example, in the Abstract, Summary, and Detailed Description sections, but not explicitly set forth in the claims, should not be incorporated into the claims, singly or collectively, by implication, inference or otherwise. For purposes of the present detailed description, unless specifically disclaimed: the singular includes the plural and vice versa; the words “and” and “or” shall be both conjunctive and disjunctive; the word “all” means “any and all”; the word “any” means “any and all”; and the words “including” and “comprising” and “having” mean “including without limitation.” Moreover, words of approximation, such as “about,” “almost,” “substantially,” “approximately,” and the like, can be used herein in the sense of “at, near, or nearly at,” or “within 3-5% of,” or “within acceptable manufacturing tolerances,” or any logical combination thereof, for example.

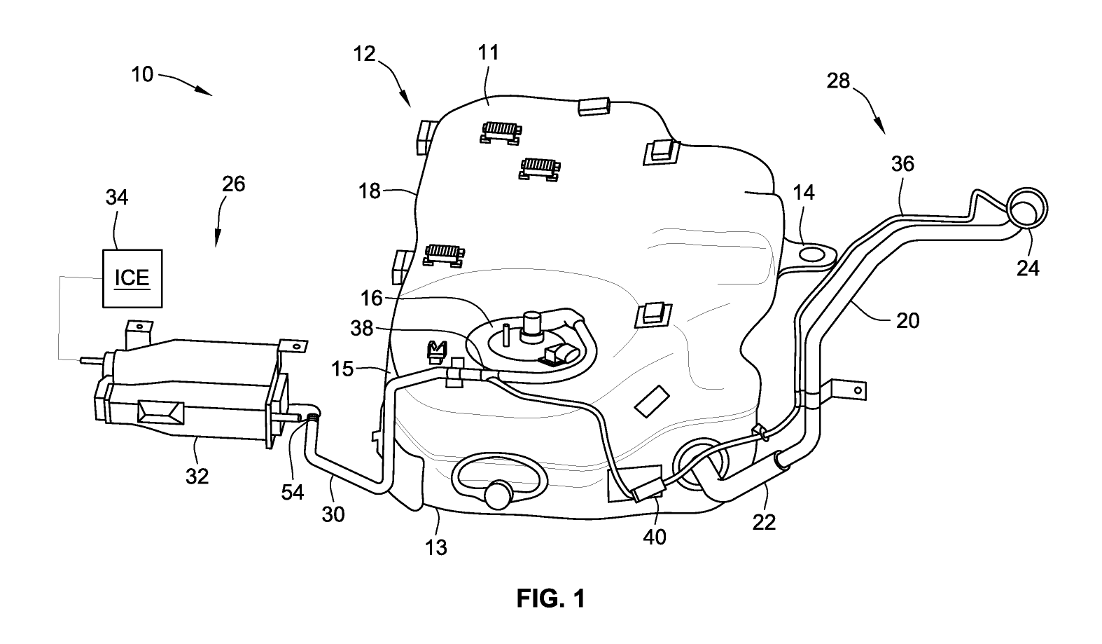

Referring now to the drawings, wherein like reference numbers refer to like features throughout the several views, there is shown in FIG. 1 a perspective-view illustration of a representative liquid containment system for stowing hydrocarbon-based liquids. This system, which is designated generally at 10, is represented herein for purposes of a more detailed discussion as a motor vehicle fuel storage system, e.g., for a passenger car, commercial vehicle or other automobile. The specific architecture of the liquid containment system 10 illustrated in FIG. 1—also referred to herein as “fuel storage system”—is merely an exemplary application with which the novel aspects of this disclosure can be practiced. In the same vein, the implementation of the present concepts into an automobile fuel system should also be appreciated as an exemplary application of the novel concepts disclosed herein. As such, it should be understood that the aspects and features of the present disclosure can be integrated into other liquid containment applications and can be utilized for any logically relevant type of motor vehicle. Lastly, the drawings presented herein are not necessarily to scale and are provided purely for instructional purposes. Thus, the specific and relative dimensions shown in the drawings are not to be construed as limiting.

According to the illustrated example, the fuel storage system 10 includes a fuel tank 12 (also referred to herein as “liquid container”) with bolt flanges 14 for mounting to a vehicle body, and a tank meter 16 for measuring a fuel level inside the tank 12. Fuel tank 12 has a fluid-tight compartment 18 for stowing a hydrocarbon based fuel, such as diesel or gasoline fuel. While any suitable size and shape can be employed, the fuel tank 12 of FIG. 1 has a 14-gallon capacity with a generally rectangular, oblong shape composed of opposing top and bottom walls 11 and 13, respectively, connected by a sidewall 15. A fuel fill pipe 20 (also referred to as “fill conduit” or “filler neck”) is fluidly coupled at a first (lower) end thereof to the fuel tank 12 via elbow pipe 22. A second (open upper) end of the fill pipe 20 is fluidly coupled to a fill cup 24, which is shaped and sized to receive therein at least the spout end of a conventional fill pump nozzle (not shown). Fuel is fed to the fuel tank 12 from the nozzle through the fill cup 24, then fill pipe 20 and lastly into elbow pipe 22.

Vapor capture and vapor recirculation capabilities are provided by hydrocarbon vapor capture and hydrocarbon vapor recirculation subsystems 26 and 28, respectively. A vapor line or conduit 30 fluidly connects the fuel tank 12 to a vapor canister 32, which allows evaporative emissions, namely hydrocarbon vapor, to be vented from the fuel tank 12 to the vapor canister 32. This vapor canister 32 absorbs and stores fuel vapor from within the fuel storage system 10. An internal combustion engine (ICE) assembly, shown schematically at 34, draws fuel vapors purged from the vapor canister 32, e.g., via a purge pump through a dedicated purge line, into an intake manifold to fuel the engine 34 as needed. The vapor canister 30 may be in the nature of, but is certainly not limited to, an activated-carbon packed canister, an activated-charcoal canister, or other known or hereinafter developed evaporative emissions canister suitable for absorbing fuel vapors in a fuel storage system. For activated-carbon canister configurations, average pore radius of the packed carbon is typically in the range of from about 12.0 to about 14.0 Angstroms, with particle diameters ranging from about 1.6 to about 3.0 mm. Heating elements activate the packed carbon for desired absorption and desorption performance. Unlike many conventional carbon canisters, the vapor canister 32 of FIG. 1 can be characterized by a lack of a bleed valve or similar structure for purging vapor to the atmosphere. In the same vein, the vapor canister 32 may be configured with a fresh-air port but designed to prevent/eliminate vapor breakthrough.

To prevent the escape of vaporized fuel from the fuel tank 12 through fill cup 24 of FIG. 1, as well as to minimize the unwanted generation of new vapor during refilling of the liquid containment system 10, a vapor recirculation line 36 permits fuel vapor to be recirculated up from the tank 12 through the fill cup 24, and back into the fill pipe 20 to mix with the incoming flow of fuel. A first (lower) end of vapor recirculation line 36 is fluidly coupled to the top wall 11 of the fuel tank 12, e.g., via fluid junction 38 to vapor line 30. Conversely, a second (upper) end of the vapor recirculation line 36 is fluidly coupled directly to the fill cup 24, e.g., below the spout opening at the upper-most end of the cup. A functional diameter of the recirculation line 36 is noticeably smaller than the functional diameter of the vapor line 30, as can be inferred from FIG. 1; thus, vapor will have a natural propensity to evacuate from the tank 12 to the vapor canister 32. During refilling, however, the aspirating effect of incoming liquid flow reduces the pressure in the fill cup 24. This creates a pressure differential that, once sufficiently large, diverts hydrocarbon vapor from the vapor line 30 into the vapor recirculation line 36. The recirculation line 36 then transmits this vapor from the fuel tank 12 to the fill pipe 20 via the fill cup 24. It may also be desirable, for at least some configurations, that vapor be transmitted by the recirculation line 36 from the fill head cup 24 to the vapor canister 32 during low in-tank pressures. As another optional configuration, the traditional mechanical filler nozzle seal that is typically disposed within many conventional fill cups to seal around the spout end of the fill pump nozzle can be altogether eliminated from the system architecture of FIG. 1.

Hydrocarbon vapor recirculation subsystem 28 provides dynamic control of recirculation flow volume to the fill pipe 20 using a multi-stage check valve assembly 40. In the architecture illustrated in FIG. 1, the check valve assembly 40 is interposed between the fuel tank 12 and fill pipe 20, integrated into the vapor recirculation line 40 fluidly upstream from the fluid-tight compartment 18 and fluidly downstream from the fill cup 24. It is also envisioned that the check valve assembly 40 be welded or otherwise attached directly to the fuel tank 12 fluidly upstream from and fluidly coupled to the vapor recirculation line 40. Other packaging locations within the liquid containment system 10 are deemed to be within the scope and spirit of the present disclosure. As another optional alternative, to support on-board vehicle diagnostics the check valve assembly 40 may be configured as a two-way valve assembly that allows vapor to flow, in a controlled manner, both towards and away from fill cup 24. Check valve assembly 40 more accurately tunes recirculation flow volume to ensure fuel flowing at high velocity down the fill pipe 20 is substantially or fully entrained with vapor rather than fresh air. In so doing, vapor generation is reduced because liquid fuel mixed with fuel vapor is typically unable to produce additional fuel vapor.

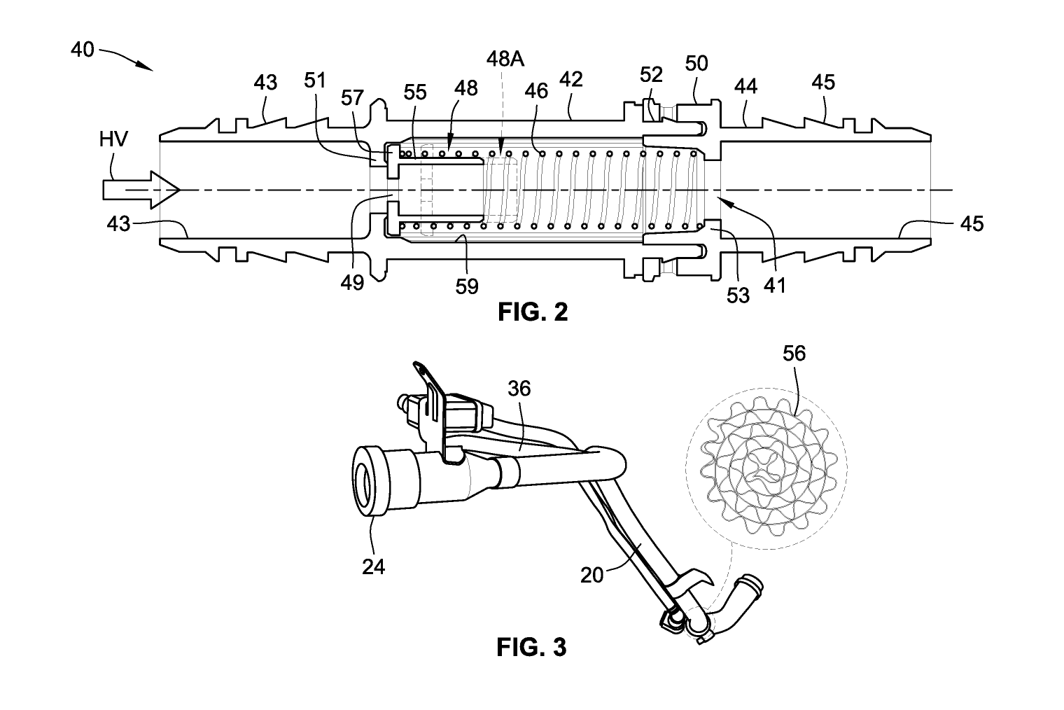

With reference to FIG. 2, the illustrated check valve assembly 40 has an elongated, tube-like bipartite housing composed of a valve body cover 44 that is attached to a cylindrical main valve body 42 to cooperatively define an internal cavity 41. As shown, the valve cover 44 includes an annular male attachment interface 50 that receives therein and snap-fits to an annular female attachment interface 52 of the valve body 42. As some alternative examples, the valve cover 44 can be operatively attached to the valve body 42 by alternative means, such as helical threads, adhesives, quick-lock connectors, etc., or may be integrally formed as a single-piece, unitary structure. Extending through a longitudinal end of the housing's main body 42 is an inlet opening 43 for receiving hydrocarbon vapor from the fuel tank 12, e.g., via vapor line 30 and recirculation line 36. An outlet opening 45 extends through the valve body cover 44 and fluidly connects to the inlet opening 43 via internal cavity 41; hydrocarbon vapor is expelled from the check valve assembly 40 via outlet opening 45. Each end of the valve housing 42, 44 includes respective line coupling adaptors 43 and 45 with one or more toroidal or helical teeth for ready installation into the vapor recirculation line 36.

A biasing member, represented herein as a helical spring 46, is packaged inside the internal cavity 41, compressed between the valve body 42 and valve cover 44. It should be appreciated that the biasing member may take on other forms, including leaf springs, torsional springs, electronically controlled linear actuators, etc., within the scope of this disclosure. A flow-control plunger 48, which includes a central bleed hole 49, is fixed to one end of the spring 46. This plunger 48 slides back-and-forth along a linear path (e.g., left-to-right in FIG. 2) within the internal cavity 41 of the housing 42, 44. Main valve body 42 includes an annular plunger shoulder 51 against which the plunger 48 seats under the biasing force of the spring 46. Likewise, the valve body cover 44 includes an annular spring shoulder 53 against which the spring seats to bias the plunger from the second position to the first position. Both the plunger shoulder 51 and spring shoulder 53 extend radially inward into the housing's internal cavity 41, each having a central through-hole for allowing passage of fuel vapor. In the illustrated example, the plunger 48 has a hollow cylindrical body 55 with a disk-shaped cap 57 at one end thereof. The bleed hole 49 extends through the center of the cap 57. The shape, size and relative proportions of the spring 46 and plunger 48 can be varied, individually or collectively, to accommodate the design parameters of different applications. For instance, the bleed hole 49 diameter, cap 57 dimensions, spring pre-load, and/or spring rate of spring 46 can be tailored to selectively tune tank pressure and recirculation flow with a high degree of accuracy and precision.

The plunger 48 reciprocates back-and-forth within the housing's internal cavity 41 between a first (seated) position and a second (unseated) position. When in the first position, shown in FIG. 2 with solid-line plunger 48, the spring 46 biases the plunger 48 to press against the housing's plunger shoulder 51. Seating the plunger 48 against the plunger shoulder 51 constricts hydrocarbon vapor flow HV to pass through only the bleed hole 49 in cap 57. Thus, vapor flow HV passing from the fuel tank 12 through the check valve assembly 40 to the fill cup 24 via the vapor recirculation line 36 is restricted to a first (reduced) flow rate. In contrast, when in-tank vapor pressure is sufficiently high to generate a line pressure force against the plunger cap 57 that exceeds the bias force of the spring 46, the plunger 48 translates rectilinearly to the second position, shown in FIG. 2 with hidden-line plunger 48A. Unseating the plunger 48 from the plunger shoulder 51 allows hydrocarbon vapor flow HV to pass both through the bleed hole 49 and around the plunger 48, e.g., via expanded diameter section 59 of the main valve body 42. Thus, vapor flow HV passing from the fuel tank 12 through the check valve assembly 40 to the fill cup 24 via the vapor recirculation line 36 is amplified to a second (increased) flow rate. According to the illustrated example, an optional flow restrictor 54 (FIG. 1), which may be in the nature of a reduced-diameter restriction, is fluidly interposed between the liquid container 12 and vapor canister 32. This flow restrictor 54 increases the internal pressure within the fuel tank 12 to modulate the operability of the check valve 40. In addition, an optional vapor generation reduction device (VGRD) 56 (FIG. 3) is fluidly coupled to fuel fill pipe 20, e.g., interposed between pipe 20 and elbow pipe 22. VGRD 56, which may be in the nature of an aerator plug, regulates in-flow fluid speed and turbulence of the hydrocarbon-based liquid discharged from the fill pump nozzle.

Vapor recirculation subsystem 28 helps to optimize the amount of recirculated fuel vapor in the fill pipe 20 to reduce fuel vapor generation and minimize vapor to the canister 32. Minimizing vapor to the canister 32 can be essential, e.g., for small displacement, turbocharged engines with limited ability to purge large amounts of fuel vapor from the vapor canister. At low fill rates (e.g., ca. 4 gals/min or less), in-tank pressures are sufficiently low such that the check valve assembly 40 remains closed and vapor flows only through the bleed hole 49 in the plunger 48. At high fill rates (e.g., ca. 10 gals/min), in-tank pressures are sufficiently high such that the check valve assembly 40 opens and allows vapor flow around the plunger 48 in addition to the flow through bleed hole 49. During a refueling event, incoming fuel running down the fill pipe 20 tends to entrain outside air which typically generates extra vapor. With the system of FIG. 1, fuel vapor is recirculated to the top of the fill pipe 20 to sufficiently saturate incoming fuel with hydrocarbon vapor and thereby reduce the amount of new vapor generated. Using the two-stage check valve assembly 40 helps to ensure a maximum amount of vapor is recirculated into the fill pipe under changing operating conditions.

While aspects of the present disclosure have been described in detail with reference to the illustrated embodiments, those skilled in the art will recognize that many changes may be made thereto without departing from the scope of the present disclosure. The present disclosure is not limited to the precise construction and compositions disclosed herein; any and all modifications, changes, and variations apparent from the foregoing descriptions are within the spirit and scope of the disclosure as defined in the appended claims. Moreover, the present concepts expressly include any and all combinations and subcombinations of the preceding elements and aspects.

1. A liquid containment system for stowing a hydrocarbon-based liquid discharged from a fill nozzle, the liquid containment system comprising:
a liquid container configured to stow therein the hydrocarbon-based liquid;
a vapor canister fluidly coupled to the liquid container and configured to receive and store hydrocarbon vapor from the hydrocarbon-based liquid stowed in the liquid container;
a fill conduit fluidly coupled to the liquid container, the fill conduit having an open end configured to receive the hydrocarbon-based liquid from the fill nozzle;
a vapor recirculation conduit fluidly coupled to the liquid container and to the fill conduit proximate the open end thereof, the vapor recirculation conduit being configured to transmit hydrocarbon vapor from the liquid container to the fill conduit; and
a multi-stage check valve assembly fluidly coupled to the liquid container and the vapor recirculation conduit, the check valve assembly having a housing and a plunger with a bleed hole, the plunger being movable within the housing to transition between a first position, whereat the plunger seats against the housing such that hydrocarbon vapor passes from the liquid container through only the bleed hole to the fill conduit via the vapor recirculation conduit, and a second position, whereat the plunger unseats from the housing such that hydrocarbon vapor passes through the bleed hole and around the plunger to the fill conduit,
wherein the plunger has a hollow cylindrical body with a disk-shaped cap at one end of the hollow cylindrical body, the disk-shaped cap defining therethrough the bleed hole and seating against the housing when the plunger is in the first position.

2. The liquid containment system of claim 1, wherein the check valve assembly further comprises a biasing member configured to bias the plunger into the first position against a first vapor pressure, and to displace in response to a second vapor pressure, greater than the first vapor pressure, to thereby allow the plunger to transition to the second position.

3. The liquid containment system of claim 1, wherein the housing includes a main valve body and a valve body cover attached to the main valve body to define an internal cavity, the plunger being rectilinearly movable back-and-forth within the internal cavity of the housing.

4. The liquid containment system of claim 1, wherein the housing includes opposing inlet and outlet openings, the inlet opening being configured to receive hydrocarbon vapor, and the outlet opening being configured to expel hydrocarbon vapor from the check valve assembly.

5. The liquid containment system of claim 1, wherein the check valve assembly further comprises a spring attached to the plunger, the housing further including a plunger shoulder against which the disk-shaped cap of the plunger seats when in the first position, and a spring shoulder against which the spring seats to bias the plunger from the second position to the first position.

6. The liquid containment system of claim 1, further comprising a flow restrictor fluidly interposed between the liquid container and the vapor canister, the flow restrictor being configured to increase an internal pressure within the liquid container.

7. The liquid containment system of claim 1, further comprising a vapor generation reduction device (VGRD) fluidly coupled to the fill conduit and configured to regulate in-flow fluid speed and turbulence of the hydrocarbon-based liquid discharged from the fill nozzle.

8. The liquid containment system of claim 7, wherein the vapor generation reduction device includes an aerator plug.

9. The liquid containment system of claim 1, wherein the check valve assembly is integrated into the vapor recirculation conduit fluidly midstream between the liquid container and the fill conduit.

10. The liquid containment system of claim 1, wherein the check valve assembly is attached directly to the liquid container fluidly midstream between the liquid container and the vapor recirculation conduit.

11. The liquid containment system of claim 1, wherein the fill conduit includes a fill cup defining the open end for receiving the fill nozzle, and wherein the vapor recirculation conduit is attached to the fill cup.

12. The liquid containment system of claim 1, wherein the liquid container includes opposing top and bottom walls connected by a sidewall, the liquid containment system further comprising a vapor conduit fluidly coupling the vapor recirculation conduit and the vapor canister to the top wall of the liquid container.

13. The liquid containment system of claim 1, wherein the hollow cylindrical body terminates at the disk-shaped cap.

14. A motor vehicle, comprising:
an engine;
a fuel tank fluidly coupled to the engine and having a fluid-tight compartment;
a vapor line fluidly coupled to the fuel tank;
a vapor canister fluidly coupled to the fuel tank via the vapor line, the vapor canister being configured to receive hydrocarbon vapor from fuel stowed in the fluid-tight compartment of the fuel tank, store the vapor, and purge the vapor to engine;
a fill pipe with a first end fluidly coupled to the fuel tank and a second end fluidly coupled to a fill cup, the fill cup being configured to receive a fill pump nozzle;
a vapor recirculation line with a first end fluidly coupled to the fuel tank via the vapor line and a second end fluidly coupled to the fill cup, the vapor recirculation line being configured to transmit hydrocarbon vapor from the fuel tank to the fill pipe via the fill cup; and
a two-stage check valve assembly fluidly coupled to the fuel tank and the vapor recirculation line, the check valve assembly having a housing, a spring disposed inside the housing, and a plunger disposed inside the housing, the plunger including a hollow cylindrical body with a disk-shaped cap at one end of the body, the cap defining therethrough a bleed hole,
wherein the plunger moves back-and-forth within the housing between a first position, whereat the spring biases the plunger to seat the cap against the housing such that hydrocarbon vapor passes from the fuel tank through only the bleed hole to the fill cup via the vapor recirculation line, and a second position, whereat in-tank vapor pressure exceeds a bias force of the spring such that the cap of the plunger unseats from the housing and hydrocarbon vapor passes through the bleed hole and around the plunger to the fill cup.

15. A method of constructing a liquid containment system for stowing a hydrocarbon-based liquid discharged from a fill nozzle, the method comprising:
fluidly coupling a vapor canister to a liquid container configured to stow therein the hydrocarbon-based liquid, the vapor canister being configured to receive and store hydrocarbon vapor from the hydrocarbon-based liquid stowed in the liquid container;
fluidly coupling a fill conduit to the liquid container, the fill conduit having an open end configured to receive the hydrocarbon-based liquid from the fill nozzle;
fluidly coupling a vapor recirculation conduit to the liquid container and to the fill conduit proximate the open end thereof, the vapor recirculation conduit being configured to transmit hydrocarbon vapor from the liquid container to the fill conduit; and
fluidly coupling a multi-stage check valve assembly to the liquid container and the vapor recirculation conduit, the check valve assembly having a housing and a plunger with a bleed hole, the plunger being movable within the housing to transition between a first position, whereat the plunger seats against the housing such that hydrocarbon vapor passes from the liquid container through only the bleed hole to the fill conduit via the vapor recirculation conduit, and a second position, whereat the plunger unseats from the housing such that hydrocarbon vapor passes through the bleed hole and around the plunger to the fill conduit,
wherein the plunger has a hollow cylindrical body with a disk-shaped cap at one end of the hollow cylindrical body, the disk-shaped cap defining therethrough the bleed hole and seating against the housing when the plunger is in the first position.

16. The method of claim 15, wherein the check valve assembly further comprises a biasing member configured to bias the plunger into the first position against a first vapor pressure, and to displace in response to a second vapor pressure, greater than the first vapor pressure, to thereby allow the plunger to transition to the second position.

17. The method of claim 15, further comprising fluidly coupling a flow restrictor between the liquid container and the vapor canister, the flow restrictor being configured to increase an internal pressure within the liquid container.

18. The method of claim 15, further comprising fluidly coupling a vapor generation reduction device (VGRD) to the fill conduit, the VGRD being configured to regulate in-flow fluid speed and turbulence of the hydrocarbon-based liquid discharged from the fill nozzle.

19. The method of claim 15, wherein fluidly coupling the check valve assembly includes integrating the check valve assembly into the vapor recirculation conduit midstream between the liquid container and the fill conduit.

20. The method of claim 15, wherein the disk-shaped cap is flat and round.
